(19) United States
(12) Patent Application Publication
(10) Pub. No.: US 2004/0253383 A1
(43) Pub. Date: Dec. 16, 2004

(54) Method for producing layers

(76) Inventors: Pavel Belik, Rodenbach (DE); Heinz-Jochen Auer, Gross-Gerau (DE); Wolfram Desch, Darmstadt (DE); Dieter Raab, Rodenbach (DE); Stefan Krall, Breuberg/Neustadt (DE); Juergen Streit, Alzenau (DE); Sybille Scholl, Rodenbach (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/495,112

(22) PCT Filed: Nov. 21, 2002
(86) PCT No.: PCT/EP02/13056

(30) Foreign Application Priority Data
Dec. 21, 2001 (DE) 101 63 681.4

(51) Int. Cl. B05D 3/02

(52) U.S. Cl. 427/384

(57) ABSTRACT

The invention relates to a method for coating a surface. According to said method, a coating substance having a viscosity of <100 Pa.s, measured at 25° C., is applied to a surface to be coated and left to harden. The inventive method is characterised in that, during the application of the coating substance, a gas flow is guided over the surface to be coated by means of at least one mobile overpressure ventilation device.

The invention relates to a method of coating a surface, in which a coating material having a viscosity <100 Pa.s is applied to a surface to be coated, and is cured. The present invention pertains in particular to the application of floor and wall coatings and also of sealing systems.

A problem which occurs frequently in the application of coatings is that the coating materials used contain volatile substances which are injurious to health and which prevent safe application of the materials without suitable protective equipment. For example, the processing of reactive resins based on methyl methacrylate or styrene to form floor coatings is normally accompanied by severe odor nuisance, and in many cases it is not possible to comply with the MAC levels that exist.

Effective removal of the volatile substances injurious to health by means of overpressure ventilation devices which are fixed, i.e., are already isolated in the building, is generally not readily possible, since they often fail to take sufficient account of the local circumstances for this purpose. Attempts to improve the efficiency of ventilation through the use of what are called air piping systems, which are usually designed in the form of hoses connected directly to the fixed overpressure ventilation devices, are unsatisfactory from a technical standpoint, since the transport of such air piping systems is inconvenient and their setup and takedown are extremely complicated and time consuming.

Nor has the use of exhaust devices become established in the art, since the highly volatile substances to be removed are generally also highly flammable. Consequently the exhaust devices to be used would have to have an antiexplosion design; the use of such exhaust devices, however, is generally too complicated and too costly for these purposes.

From the art it is known, therefore, to use reduced-odor coating materials, especially reduced-odor methacrylate systems. Thus, for example, Japanese laid-open specification JP 95-46571 discloses a system that comprises unsaturated resins, cyclopentadienyl (meth)acrylates, crosslinking agents, such as organic peroxides, for example, and accelerants, such as metal salts of organic acids, for example.

A system comprising cumene hydroperoxide and cobalt octoate as curative and accelerant has been shown to cure.

Further systems, likewise using cumene hydroperoxide and cobalt octoate, are described by Japanese laid-open specifications JP 95-5661 and JP 94-199 427.

Although these systems do solve the problem of the odor nuisance, a health hazard remains when these systems are applied, owing to the use of the problematic initiating system comprising Co compound and cumene hydroperoxide.

The publication DE 198 26 412 describes cold-curing reactive (meth)acrylate resins for coatings, with a reduction in odor and in the health hazard being achieved by means which include restricting the fractions of methyl (meth)acrylate and ethyl (meth)acrylate to <5% by weight, based on the overall compositions. Although coatings having very useful properties can already be obtained by using these reactive resins, for many fields of application the industry requires coatings having higher fractions of methyl (meth)acrylate and/or ethyl (meth)acrylate, in order to be able to tailor the spectrum of properties of the coatings in accordance with the user's wishes.

In view of the state of the art it is therefore an object of the present invention to provide a method of coating a surface which further minimizes the health hazard involved in applying the coating material. This method should as far as possible be capable of universal use and as far as possible should not be subject to any restrictions in respect of the coating materials which can be used, so that the spectrum of properties of the coatings can be optimized specifically as a function of the respective application.

This object and other objects which, although not explicitly mentioned, can nevertheless be readily inferred or deduced from the circumstances discussed herein are solved by a method of producing a reduced-odor coating having all of the features of claim 1. Advantageous modifications of the method of the invention are protected in the subclaims appendant to claim 1.

As a result of the provision of a method of coating a surface, in which a coating material having a viscosity of <100 Pa.s, measured at 25° C., is applied to a surface to be coated, and is cured, the method being distinguished by the fact that, during the application of the coating material, a gas flow is passed over the surface to be coated, by means of at least one mobile overpressure ventilation device, it is possible, in a way which was not readily foreseeable, to achieve a marked reduction in the health hazard involved in applying these systems, so that the coating materials can be applied even in enclosed spaces while complying with the MAC levels that exist. At the same time the method of the invention allows a series of further advantages to be achieved:

The method of the invention is not restricted to the use of substances which are unobjectionable from a health standpoint. Instead, the coating material can be optimized through appropriate selection of the individual constituents in accordance with nature and amount, independently of their MAC levels, so that coatings having a spectrum of properties which is outstanding overall can be produced;

full curing of the coating material is further accelerated by the method of the invention, so that after 0.5 to 5 hours, preferably after <2 hours, reactive (meth)acrylate resins, for example, are no longer tacky;

the curing of the coating materials can be improved still further by using particular accelerants and initiators;

effective adhesion to many substrates, such as plastics, screeds, concrete; and

very substantial paucity of odor during and after application.

In the context of the present invention a surface is coated by a coating material being applied to a surface to be coated and being cured. The term “coating” is known to the skilled worker. According to DIN 8580 (July 1985) coating is understood as a finishing method for applying a firmly adhering coat of formless substance to a workpiece or a carrier web. In accordance with the invention coating takes place by application of a liquid, pulpy or pasty coating material; i.e., it embraces painting, brushing, varnishing, dispersion coating or melt coating, among others.

The coating materials can be applied in principle to all solid substrates, particular suitability being possessed by asphalt, screed, including bitumen screed, concrete, including asphaltic concrete, ceramic tiles, metal, such as steel or aluminum, for example, and wood. Depending on the nature of the substrate it is advantageous to apply a primer to the substrate before the coating material is applied. These primers are widely known in the art and can generally be obtained commercially.

In accordance with the invention the coating material at 25° C. and atmospheric pressure (101325 Pa) has a dynamic viscosity <100 Pa.s, preferably in the range from 0.1 mPa.s to 10 Pa.s.

There are numerous materials suitable for use as coating materials, especially natural (rubber) and synthetic polymers (plastics), which can be applied in the form of melts, organic solutions, organosols, plastisols or aqueous dispersions, surface-coating materials (e.g., paints, adhesives). For the purposes of the present invention, nevertheless, it has proven particularly advantageous to use coating materials which comprise what are called reactive resins containing

A) 1 part by weight of at least one ethylenically unsaturated compound,

B) 0-2 parts by weight of a (pre)polymer swellable or soluble in A),

C) 0 to 0.15 parts by weight of at least one paraffin and/or wax,

D) a redox system which as far as at least one component of the redox system is concerned is to be kept separate until the polymerization of the polymerizable constituents of the system, and which comprises an accelerant and a peroxide catalyst or initiator in an amount sufficient for the cold curing of component A), and

E) customary additives.

Component A

The ethylenically unsaturated compound A) embraces all those organic compounds which have at least one ethylenic double bond. These include, among others:

nitriles of (meth)acrylic acid and other nitrogen-containing methacrylates, such as methacryloylamidoacetonitrile, 2-methacryloyloxyethylmethylcyanamide, cyanomethyl methacrylate;

(meth)acrylates which derive from saturated alcohols, such as methyl (meth)acrylate, ethyl (meth)acrylate, n-propyl (meth)acrylate, isopropyl (meth)acrylate, n-butyl (meth)acrylate, sec-butyl (meth)acrylate, tert-butyl (meth)acrylate, pentyl (meth)acrylate, n-hexyl (meth)acrylate, heptyl (meth)acrylate, 2-ethylhexyl (meth)acrylate, n-octyl (meth)acrylate, nonyl (meth)acrylate, isooctyl (meth)acrylate, isononyl (meth)acrylate, 2-tert-butylheptyl (meth)acrylate, 3-isopropylheptyl (meth)acrylate, n-decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate and/or eicosyltetratriacontyl (meth)acrylate;

cycloalkyl (meth)acrylates, such as cyclopentyl (meth)acrylate, cyclohexyl (meth)acrylate, 3-vinyl-2-butylcyclohexyl (meth) acrylate, bornyl (meth) acrylate, 3-vinylcyclohexyl (meth)acrylate, 3,3,5-trimethylcyclohexyl (meth)acrylate, cyclopenta-2,4-dienyl (meth)acrylate, isobornyl (meth)acrylate, and 1-methylcyclohexyl (meth)acrylate;

(meth)acrylates which derive from unsaturated alcohols, such as 2-propynyl (meth)acrylate, allyl (meth)acrylate, and oleyl (meth)acrylate, vinyl (meth)acrylate;

aryl (meth)acrylates, such as benzyl (meth)acrylate, nonylphenyl (meth)acrylate or phenyl (meth)acrylate, it being possible for the aryl radicals in each case to be unsubstituted or to be substituted up to four times;

hydroxyalkyl (meth)acrylate, such as 3-hydroxypropyl (meth)acrylate, 3,4-dihydroxybutyl (meth)acrylate, 2-hydroxyethyl (meth)acrylate, 2-hydroxypropyl (meth)acrylate, 2,5-dimethyl-1,6-hexanediol (meth)acrylate, 1,10-decanediol (meth)acrylate, 1,2-propanediol (meth)acrylate;

polyoxyethylene and polyoxypropylene derivatives of (meth)acrylic acid, such as triethylene glycol (meth)acrylate, tetraethylene glycol (meth)acrylate, tetrapropylene glycol (meth)acrylate;

di(meth)acrylates, such as 1,2-ethanedioldi(meth)acrylate, 1,2-propanedioldi(meth)acrylate, 1,3-butanediol methacrylate, 1,4-butanedioldi(meth)acrylate, 2,5-dimethyl-1,6-hexanedioldi(meth)acrylate, 1,10-decanedioldi(meth)acrylate, diethylene glycol di(meth)acrylate, dipropylene glycol di(meth)acrylate, triethylene glycol di(meth)acrylate, tripropylene glycol di(meth)acrylate, tetraethylene glycol di(meth)acrylate, tetrapropylene glycol di(meth)acrylate, polyethylene glycol di(meth)acrylate (preferably having a weight average of the molecular weight in the range of 200-5 000 000 g/mol, advantageously in the range from 200 to 25 000 g/mol, in particular in the range from 200 to 1000 g/mol), polypropylene glycol di(meth)acrylate (preferably having a weight average of the molecular weight in the range of 200-5 000 000 g/mol, advantageously in the range from 250 to 4000 g/mol, in particular in the range from 250 to 1000 g/mol), 2,2′-thiodiethanoldi(meth)acrylate (thiodiglycol di(meth)acrylate), 3,9-di(meth)acryloyloxymethyltricyclo[5.2.1.0(2,6)]decane, especially

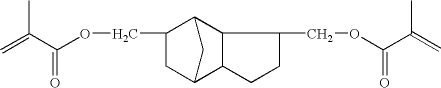

3,8-di(meth)acryloyloxymethyltricyclo[5.2.1.0(2,6)]-decane,

4,8-di(meth)acryloyloxymethyltricyclo[5.2.1.0(2,6)]-decane,

4,9-di(meth)acryloyloxymethyltricyclo[5.2.1.0(2,6)]-decane, ethoxylated bisphenol A di(meth)acrylate, especially

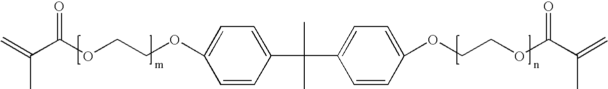

where m and n are greater than or equal to zero and the sum m+n is preferably in the range from 1 to 3, in particular in the range from 1.5 to 2.5; and di(meth)acrylates obtainable by reacting diisocyanates with 2 equivalents of hydroxyalkyl (meth)acrylate, especially

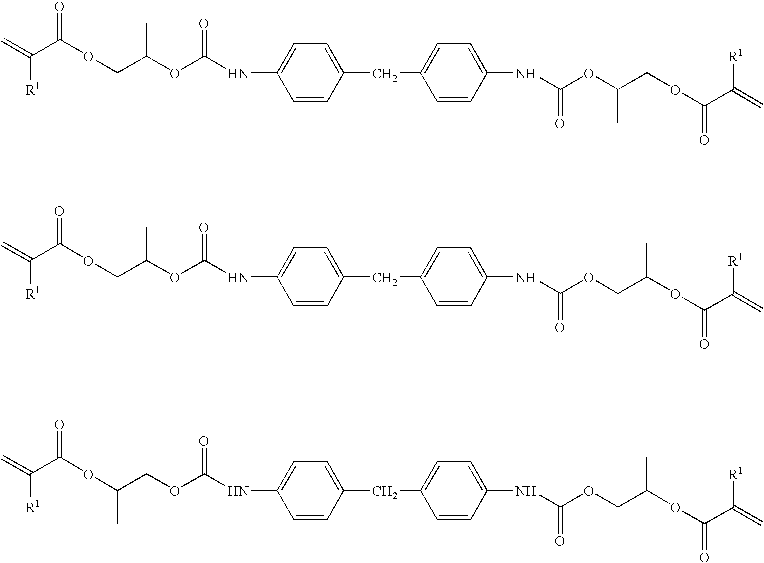

where the radical R¹ in each case independently of the others is hydrogen or a methyl radical;

aminoalkyl (meth)acrylates, such as tris(2-methacryloyloxyethyl)amine, N-methylformamidoethyl (meth)acrylate, 3-diethylaminopropyl (meth)acrylate, 2-ureidoethyl (meth)acrylate;

carbonyl-containing (meth)acrylates, such as 2-carboxyethyl (meth)acrylate, carboxymethyl (meth)acrylate, oxazolidinylethyl (meth)acrylate, N-(methacryloyloxy)formamide, acetonyl (meth)acrylate, N-(2-methacryloyloxyethyl)-2-pyrrolidinone, N-(3-methacryloyloxypropyl)-2-pyrrolidinone, N-methacryloylmorpholine, N-methacryloyl-2-pyrrolidinone;

(meth)acrylates of ether alcohols, such as tetrahydrofurfuryl (meth)acrylate, vinyloxyethoxyethyl (meth)acrylate, methoxyethoxyethyl (meth)acrylate, 1-butoxypropyl (meth)acrylate, 1-methyl(2-vinyloxy)ethyl (meth)acrylate, cyclohexyloxymethyl (meth)acrylate, methoxymethoxyethyl (meth)acrylate, benzyloxymethyl (meth)acrylate, furfuryl (meth)acrylate, 2-butoxyethyl (meth)acrylate, 2-ethoxyethoxymethyl (meth)acrylate, 2-ethoxyethyl (meth)acrylate, allyloxymethyl (meth)acrylate, 1-ethoxybutyl (meth)acrylate, methoxymethyl (meth)acrylate, 1-ethoxyethyl (meth)acrylate, ethoxymethyl (meth)acrylate;

(meth)acrylates of halogenated alcohols, such as 2,3-dibromopropyl (meth)acrylate, 4-bromophenyl (meth)acrylate, 1,3-dichloro-2-propyl (meth)acrylate, 2-bromoethyl (meth)acrylate, 2-iodoethyl (meth)acrylate, chloromethyl (meth)acrylate;

oxiranyl (meth)acrylates, such as 2,3-epoxybutyl (meth)acrylate, 3,4-epoxybutyl (meth)acrylate, 2,3-epoxycyclohexyl (meth)acrylate, 10,11-epoxyundecyl (meth)acrylate, glycidyl (meth)acrylate;

amides of (meth)acrylic acid, such as N-(3-dimethylaminopropyl)(meth)acrylamide, N-(diethylphosphono)(meth)acrylamide, 1-(meth)acryloylamido-2-methyl-2-propanol, N-(3-dibutylaminopropyl)(meth)acrylamide, N-t-butyl-N-(diethylphosphono)(meth)acrylamide, N,N-bis (2-diethylaminoethyl) (meth) acrylamide, 4-(meth)acryloylamido-4-methyl-2-pentanol, N-(methoxymethyl)(meth)acrylamide, N-(2-hydroxyethyl)(meth)acrylamide, N-acetyl(meth)acrylamide, N,N-(dimethylaminoethyl)(meth)acrylamide, N-methyl-N-phenyl(meth)acrylamide, N,N-diethyl(meth)acrylamide, N-methyl(meth)acrylamide, N,N-dimethyl(meth)acrylamide, N-isopropyl(meth)acrylamide;

heterocyclic (meth)acrylates, such as 2-(1-imidazolyl)ethyl (meth)acrylate, 2-(4-morpholinyl)ethyl (meth)acrylate, and 1-(2-methacryloyloxyethyl)-2-pyrrolidone;

(meth)acrylates containing phosphorus, boron and/or silicon, such as 2-(dimethylphosphato)propyl (meth)acrylate, 2-(ethylenephosphito)propyl (meth)acrylate, 2,3-butylenemethacryloylethyl borate, 2-(dimethylphosphato)propyl methacrylate, methyldiethoxymethacryloylethoxysilane, diethylphosphatoethyl methacrylate, dimethylphosphinomethyl (meth)acrylate, dimethylphosphonoethyl (meth)acrylate, diethyl (meth)acryloylphosphonate, dipropyl (meth)acryloyl phosphate;

(meth)acrylates containing sulfur, such as ethylsulfinylethyl (meth)acrylate, 4-thiocyanatobutyl (meth)acrylate, ethylsulfonylethyl (meth)acrylate, thiocyanatomethyl (meth)acrylate, methylsulfinylmethyl (meth)acrylate, bis(meth)acryloyloxyethyl) sulfide;

tri(meth)acrylates, such as trimethyloylpropanetri(meth)acrylate and glycerol tri(meth)acrylate;

bis(allylcarbonates), such as ethylene glycol bis(allylcarbonate), 1,4-butanediol bis(allylcarbonate), diethylene glycol bis(allylcarbonate);

vinyl halides, such as vinyl chloride, vinyl fluoride, vinylidene chloride, and vinylidene fluoride, for example;

vinyl esters, such as vinyl acetate;

styrene, substituted styrenes having an alkyl substituent in the side chain, such as α-methylstyrene and α-ethylstyrene, for example, substituted styrenes having an alkyl substituent on the ring, such as vinyl toluene and p-methylstyrene, halogenated styrenes, such as monochlorostyrenes, dichlorostyrenes, tribromostyrenes, and tetrabromostyrenes, for example;

heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;

vinyl ethers and isoprenyl ethers;

maleic acid and maleic acid derivatives, such as monoesters and diesters of maleic acid, for example, the alcohol residues having 1 to 9 carbon atoms,

maleic anhydride, methylmaleic anhydride, maleimide, methylmaleimide;

fumaric acid and fumaric acid derivatives, such as monoesters and diesters of fumaric acid, for example, the alcohol residues having 1 to 9 carbon atoms;

and dienes, such as 1,2-divinylbenzene, 1,3-divinylbenzene, 1,4-divinylbenzene, 1,2-diisopropenylbenzene, 1,3-diisopropenylbenzene, and 1,4-diisopropenylbenzene, for example.

In this context the expression (meth)acrylates embraces methacrylates and acrylates and also mixtures of both. Correspondingly the expression (meth)acrylic acid embraces methacrylic acid and acrylic acid and also mixtures of both.

The ethylenically unsaturated monomers can be used individually or as mixtures.

The preferred unsaturated compounds A) include acrylates, methacrylates and/or vinylaromatics, especially methyl methacrylate, n-butyl (meth)acrylate, ethylhexyl acrylate and/or styrene.

In accordance with the invention it has been found especially appropriate to use reactive resins containing

| | |
|---|---|
| A-1) (meth)acrylate | 10-100% by wt., including |
| C₁-C₆ (meth)acrylate | 0-97% by wt., |
| ≧C₇ (meth)acrylate | 0-50% by wt. and |
| polyfunctional (meth)acrylates | 0.1-10% by wt., |
| and if desired | |
| A-2) comonomers | 0-90% by wt., including |
| Vinylaromatics | 0-30% by wt. and |
| vinyl esters | 0-30% by wt., |

the sum of components A-1) and A-2) making 100% by weight.

Preference is given here to (meth)acrylates whose alcohol residue contains one to five carbon atoms. Longer-chain esters, i.e., compounds whose alcohol residue contains 7 or more carbon atoms, render the coatings more flexible but at the same time softer, thereby restricting their service properties. Their fraction is therefore limited preferably to 50% by weight.

Component A) contains advantageously between 0.1 and 10% by weight of one or more polyfunctional (meth)acrylates.

These include, among others, compounds with a functionality of two, three or more. Particular preference is enjoyed by difunctional (meth)acrylates and also trifunctional (meth)acrylates.

(a) Difunctional (meth)acrylates

Compounds of the general formula:

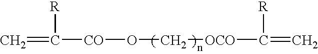

in which R is hydrogen or methyl and n is a positive integer between 3 and 20, such as di(meth)acrylate of propanediol, of butanediol, of hexanediol, of octanediol, of nonanediol, of decanediol, and of eicosanediol, for example;

Compounds of the general formula:

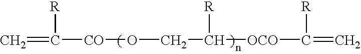

in which R is hydrogen or methyl and n is a positive integer between 1 and 14, such as di(meth)acrylate of ethylene glycol, of diethylene glycol, of triethylene glycol, of tetraethylene glycol, of dodecaethylene glycol, of tetradecaethylene glycol, of propylene glycol, of dipropyl glycol, and of tetradecapropylene glycol, for example;

and glycerol di(meth)acrylate, 2,2′-bis[p-(g-methacryloyloxy-b-hydroxypropoxy)phenylpropane] or bis-GMA, biphenol A dimethacrylate, neopentyl glycol di(meth)acrylate, 2,2′-di(4-methacryloyloxypolyethoxyphenyl)propane having 2 to 10 ethoxy groups per molecule, and 1,2-bis(3-methacryloyloxy-2-hydroxypropoxy)butane.

(b) (Meth)acrylates with a functionality of three or more

trimethylolpropanetri(meth)acrylates and pentaerythritol tetra(meth)acrylate.

(c) Urethane (meth)acrylates

reaction products of 2 mol of hydroxyl-containing (meth)acrylate monomer with one mole of diisocyanate and

reaction products of a urethane prepolymer having two NCO end groups with a methacrylic monomer containing a hydroxyl group, as are reproduced, for example, by the general formula:

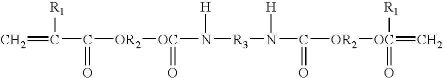

in which R₁ is hydrogen or a methyl group, R² is an alkylene group, and R³ embodies an organic radical.

The stated crosslinking monomers a) to c) are used either alone or in the form of a mixture of two or more monomers.

The polyfunctional monomers which can be used with very particular advantage include above all trimethylolpropane trimethacrylate (TRIM), 2,2-bis-4(3-methacryloyloxy-2-hydroxypropoxy)phenylpropane (bis-GMA), 3,6-dioxaoctamethylene dimethacrylate (TEDMA), 7,7,9-trimethyl-4,13-dioxo-3,14-dioxa-5,12-diazahexadecane-1,16-dioxy dimethacrylate (UDMA) and/or 1,4-butanediol dimethacrylate (1,4-BDMA). Of these, 1,4-butanediol dimethacrylate is in turn by far preferred.

Comonomers in the sense of this preferred embodiment are all ethylenically unsaturated compounds which are copolymerizable with abovementioned (meth)acrylates. These include, among others, vinyl esters, vinyl chloride, vinylidene chloride, vinyl acetate, styrene, substituted styrenes having an alkyl substituent in the side chain, such as α-methylstyrene and α-ethylstyrene, for example, substituted styrenes having an alkyl substituent on the ring, such as vinyltoluene and p-methylstyrene, for example, halogenated styrenes, such as monochlorostyrenes, dichlorostyrenes, tribromostyrenes, and tetrabromostyrenes, for example, vinyl ethers and isopropenyl ethers, maleic acid derivatives, such as maleic anhydride, methylmaleic anhydride, maleimide, methylmaleimide, phenylmaleimide, and cyclohexylmaleimide, for example, and dienes, such as 1,3-butadiene and divinylbenzene, for example.

The fraction of the comonomers is preferably limited to not more than 90% by weight, in particular to not more than 50% by weight of the sum of components A-1) and A-2), since otherwise the mechanical properties of the polymerized coatings may be adversely affected. The fraction of the vinylaromatics in this case is preferably limited to 30% by weight of the sum of components A-1) and A-2), since higher fractions can lead to separation of the system. The fraction of the vinyl esters is preferably likewise limited to 30% by weight of the sum of components A-1) and A-2), since at low temperatures they do not exhibit satisfactory cure through volume, and tend toward an unfavorable contraction behavior.

All of the abovementioned monomers which may be present in component A) are available commercially.

Component B)

In order to adjust the viscosity of the reactive resin and the flow properties and also for the better curing or other properties of the resin or of the polymerized coating it is possible to add a polymer or prepolymer to component A). Said (pre)polymer should be swellable or soluble in component A). To one part by weight of A) it is preferred to use between 0 and 2 parts by weight of the (pre)polymer.

Of particular suitability as component B) are, for example, poly(meth)acrylates which can be dissolved as solid polymer in A). They can likewise be used as what are called syrups, i.e., as partly polymerized compositions of corresponding monomers.

Suitability extends, inter alia, to polyvinyl chlorides, polyvinyl acetates, polystyrenes, epoxy resins, epoxy (meth)acrylates, unsaturated polyesters, polyurethanes or mixtures thereof, or with abovementioned poly(meth)acrylates, as component B). Said (pre)polymers can also be used as copolymers.

(Pre)polymers which can be used with particular success in the context of the invention include binders based on (meth)acrylates which do not release any monomer, such as ®DEGALAN LP, for example, which is available from Rohm GmbH.

These polymers serve, for example, to regulate the flexibility properties, the regulation of contraction, as a stabilizer, as a skin former, and as a flow improver.

The abovementioned (pre)polymers are generally available commercially. Alternatively they can be prepared in a manner known to the skilled worker.

Reactive resins which are developed for producing thin coatings with a thickness of below 5 mm preferably contain at least 1% by weight, more preferably at least 10% by weight of a polymer, e.g., of a poly(meth)acrylate, based on the sum A)+B).

Component C)

Reactive resins exhibit a tendency to air inhibition on curing. This results in the upper resin layers, which are able to come into contact with air, to remain tacky to an increased extent and not to become solid, like the rest of the material. In order to prevent or improve this behavior therefore, a reactive resin, in particular a methacrylate resin, is admixed with paraffins and/or waxes which in terms of their concentration are preferably close to the solubility limit. When constituents of the formula evaporate the solubility limit is exceeded, and a fine paraffin film is formed on the surface, this film effectively preventing air inhibition of the upper resin layers and so leading to a dry surface.

Waxes and paraffins are generally apolar substances which dissolve in the liquid, uncured resin. With increasing crosslinking during the polymerization, their compatibility with the resin decreases, so that they are able to form a second phase and migrate to the surface of the polymerizing resin material. They are then capable of forming a coherent film on the surface, and are able to close off this material from atmospheric oxygen. By means of this exclusion of the oxygen the polymerization of the resin at its surface is assisted. In particular, the addition of waxes and/or paraffins thus reduces the tackiness of the surface, thereby allowing the inhibitor effect of oxygen to be counteracted.

Suitable in principle are all substances which exhibit the above-described behavior of homogeneous surface-layer formation on going below the solubility limits.

Suitable waxes include, among others, paraffin, micro-crystalline wax, carnauba wax, beeswax, lanolin, sperm oil, polyolefin waxes, ceresin, candelilla wax, and the like.

Paraffins, however, have proven particularly suitable. They consist predominantly of straight-chain hydrocarbons of the general formula CₙH₂ₙ₊₂ with n=10−70 and with a fraction of iso- and cyclo-alkanes/-paraffins of from 0 to 60%. These waxes, obtained from the vacuum distillation cuts of light and medium lubricating oils, possess the advantage that they are extremely unreactive under the conditions which prevail in (meth)acrylate resins. They are insoluble in water and virtually insoluble in low molecular mass aliphatic alcohols and ethers. Their solubility in ketones, chlorinated hydrocarbons, benzine, benzene, toluene, xylene, and higher aromatics is better. The solubility decreases as the melting point rises, i.e., as the molar mass of the wax becomes greater. The softening points of the microcrystalline paraffins are between 35 and 72. The standard commercial products exhibit viscosities at 100° C. of between 2 and 10 mm²/s.

Waxes which have proven preferable for use in reactive resins, especially for floor coating, include fully refined and deoiled waxes. The oil content of these grades is not more than 2.5%. Particular preference is given to products having a softening point of between 40° C. and 60° C. and a viscosity at 100° C. of from 2.0 to 5.5 mM²/s.

The waxes and/or paraffins are added preferably in amounts of from 0.1 to 5% by weight, more preferably 1% by weight, based on the total weight of components A) to B). If the amount of wax and/or paraffin added significantly exceeds a level of 5% by weight, this can have a deleterious effect on the strength of the floor coating. If the amount of wax and/or paraffin added is below a level of 0.1%, the reduced-odor resins do not exhibit tack-free curing.

Since the paraffins and/or waxes exhibit their effect according to the invention by means of evaporation, it is favorable for component A) to exhibit evaporation sufficiently. Consequently particular preference is given to (meth)acrylate monomers with ester groups containing 1-6 carbon atoms.

Component D)

The reactive resin is advantageously suitable for cold curing, i.e., for polymerization it comprises preferably a redox system made up of an accelerant and a peroxide catalyst or initiator. The amounts in which these accelerants and initiators are added are dependent on each particular system and can be determined by the skilled worker by means of routine experiments. However, they should be sufficient for the cold curing of component A).

The accelerant is normally added in an amount of from 0.01 to 5% by weight, preferably from 0.5 to 1.5% by weight, based on the sum of components A) to E). The compounds which are particularly suitable as accelerants include, among others, amines and mercaptans, such as N,N-dimethyl-p-toluidine, N,N-diisopropoxy-p-toluidine, N,N-bis(2-hydroxyethyl)-p-toluidine, N,N-dimethylaniline, and glycol dimercaptoacetate, for example, with very particular preference being given to N,N-bis(2-hydroxyethyl)-p-toluidine and N,N-dimethyl-p-toluidine.

It is additionally possible for organic metal salts to act as accelerants, these salts being used normally in the range from 0.001 to 2% by weight, based on the sum of components A) to E). These accelerants include copper naphthenate and copper oleate.

Groups of compounds particularly suitable as the peroxide catalyst or initiator include those such as ketone peroxides, diacyl peroxides, peresters, perketals, and mixtures of compounds of these groups with one another and with active curatives and initiators that have not been mentioned.

Particular preference for this purpose is given to compounds, such as methyl ethyl ketone peroxide, acetylacetone peroxide, ketone peroxide, methyl isobutyl ketone peroxide, cyclohexanone peroxide, dibenzoyl peroxide, tert-butyl peroxybenzoate, tertbutyl peroxyisopopyl carbonate, 2,5-bis(2-ethylhexanoylperoxy)-2,5-dimethylhexane, tert-butyl peroxy-2-ethylhexanoate, tert-butyl peroxy-3,5,5-trimethylhexanoate, 1,1-bis(tert-butylperoxy)cyclohexane, 1,1-bis(tert-butylperoxy)-3,3,5-trimethylcyclohexane, cumyl hydroperoxide, tert-butyl hydroperoxide, dicumyl peroxide, bis(4-tert-butylcyclohexyl) peroxydicarbonate, mixtures of ketone-peroxide grades, perester grades, and mixtures of two or more of the aforementioned compounds with one another. Of the abovementioned compounds, dibenzoyl peroxide is particularly advantageous.

The initiators are used normally in an amount in the range from 0.1 to 10% by weight, preferably from 0.5 to 5% by weight, based on the sum of components A) to E). In the resin it is possible, of component D), for the accelerants, e.g., N,N-dimethyl-p-toluidine, to be present already, without polymerization occurring at ambient temperature. The reaction is initiated by addition of the remaining constituents of component D), component D) normally being calculated such that the (meth)acrylate system has a pot life of 10 min to 20 min. The (meth)acrylate system of the invention therefore contains the full component D) only immediately prior to application; up until the time of use, component D) is absent or is only partly present, or, in other words, the complete functional redox system is to be kept away from the polymerizable constituents until they polymerize, whereas individual constituents of the redox system may already have been premixed with polymerizable substances.

Component E

Component E) is optional. It includes a multiplicity of additives which are customary in (meth)acrylate reactive resin for floor coatings. Those that may be mentioned merely by way of example include the following:

setting agents, antistats, antioxidants, biostabilizers, chemical blowing agents, mold release agents, flame retardants, lubricants, colorants, flow improvers, fillers, slip agents, adhesion promoters, inhibitors, catalysts, light stabilizers, optical brighteners, organic phosphites, oils, pigments, impact modifiers, reinforcing agents, reinforcing fibers, weathering protectants, and plasticizers.

These optional additives can be present in varying amounts in the reactive resin. Certain additives are particularly preferred in the context of the invention, such as the additives of groups E1) to E4), for example.

Group E1)

Particular interest as additions to the reactive resins attaches to the group of inhibitors E1).

Inhibitors are advantageously added to the polymerizable resin mixture in order to protect against unwanted, premature curing. These inhibitors act as free-radical chain-transfer reagents, to scavenge the free radicals that are normally present, and considerably increase the storage properties of the resin formulations. In the case of curing initiated deliberately by adding organic peroxides, however, the added inhibitors have the advantage of being rapidly overridable. 1,4-Dihydroxybenzenes are used predominantly. It is, however, also possible for differently substituted dihydroxybenzenes to be employed. In general such inhibitors can be represented by the general formula (E1.I)

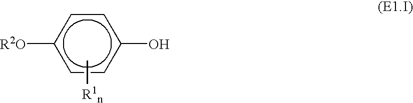

in which

R¹ is a linear or branched alkyl radical having one to eight carbon atoms, halogen or aryl, preferably an alkyl radical having one to four carbon atoms, more preferably methyl, ethyl, n-propyl, isopropyl, n-butyl, isobutyl, sec-butyl, tert-butyl, Cl, F or Br;

n is an integer in the range from one to four, preferably one or two; and

R² is hydrogen, a linear or branched alkyl radical having one to eight carbon atoms or aryl, preferably an alkyl radical having one to four carbon atoms, more preferably methyl, ethyl, n-propyl, isopropyl, n-butyl, isobutyl, sec-butyl or tert-butyl.

It is, however, also possible to use compounds with 1,4-benzoquinone as their parent compound. These compounds can be described by the formula (E1.II)

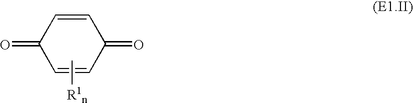

in which

R¹ is a linear or branched alkyl radical having one to eight carbon atoms, halogen or aryl, preferably an alkyl radical having one to four carbon atoms, more preferably methyl, ethyl, n-propyl, isopropyl, n-butyl, isobutyl, sec-butyl, tert-butyl, Cl, F or Br; and

n is an integer in the range from one to four, preferably one or two.

Use is also made of phenols of the general structure (E1.III)

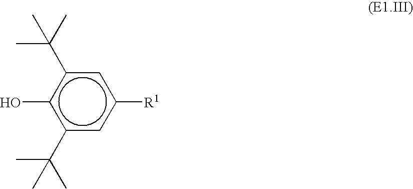

in which

R¹ is a linear or branched alkyl radical having one to eight carbon atoms, aryl or aralkyl, proprionic esters with 1 to 4 hydric alcohols, which may also contain heteroatoms such as S, O, and N, preferably an alkyl radical having one to four carbon atoms, more preferably methyl, ethyl, n-propyl, isopropyl, n-butyl, isobutyl, sec-butyl, tert-butyl.

A further advantageous class of substances is represented by hindered phenols based on triazine derivatives of the formula (E1.IV)

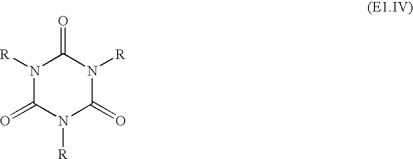

with R=compound of the formula (E1.V)

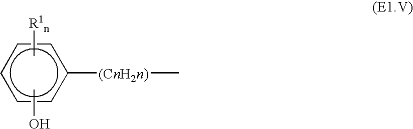

in which

R¹=CₙH₂ₙ₊₁

where n=1 or 2.

Employed with particular success are the compounds 1,4-dihydroxybenzene, 4-methoxyphenol, 2,5-dichloro-3,6-dihydroxy-1,4-benzoquinone, 1,3,5-trimethyl-2,4,6-tris(3,5-di-tert-butyl-4-hydroxybenzyl)benzene, 2,6-di-tert-butyl-4-methylphenol, 2,4-dimethyl-6-tert-butyl-phenol, 2,2-bis[3,5-bis(1,1-dimethylethyl)-4-hydroxyphenyl-1-oxoperopoxymethyl)]-1,3-propanediyl ester, 2,2′-thiodiethyl bis[3-(3,5-di-tert-butyl-4-hydroxyphenyl)]propionate, octadecyl 3-(3,5-di-tert-butyl-4-hydroxyphenyl)propionate, 3,5-bis(1,1-dimethylethyl-2,2-methylenebis(4-methyl-6-tert-butyl)phenol, tris(4-tert-butyl-3-hydroxy-2,6-dimethylbenzyl)-s-triazine-2,4,6-(1H,3H,5H)trione, tris(3,5-di-tert-butyl-4-hydroxy)-s-triazine-2,4,6-(1H,3H,5H)trione or tert-butyl-3,5-dihydroxybenzene.

Based on the weight of the overall resin formula the fraction of the inhibitors individually or as a mixture is generally 0.0005-1.3% (wt/wt).

Group E2)

Another important group of substances within the additives and additaments are the fillers E2).

Suitable fillers and/or pigments in the liquid resin formulation include all customary additions such as, for example, natural and synthetic calcium carbonates, dolomites, calcium sulfates, silicates such as aluminum silicate, zirconium silicate, talc, kaolin, mica, feldspar, nepheline syelite, wollastonite, but also glass beads or silicate beads, silicon dioxide in the form of sand, quartz, quartzite, novaculite, perlite, tripoli, and diatomaceous earth, barium sulfates, carbides such as, for example, SiC, sulfides (e.g., MOS₂, ZnS) or else titanates such as, for example, BaTiO₃, molybdates such as, for example, zinc, calcium, barium, and strontium molybdates, phosphates such as, for example, zinc, calcium, and magnesium. Likewise highly suitable are metal powders or metal oxides such as Al powder, silver powder or aluminum hydroxide, for example. Also employed are carbon blacks, graphite powders, wood flour, synthetic fibers (based on polyethylene terephthalate, polyvinyl alcohol), basalt fibers, C fibers, aramid fibers, polybenzimidazole fibers, PEEK fibers, polyethylene fibers, boron fibers, ceramic fibers. Customary percentage amounts relative to the overall formula are between 0 and 60% wt/wt.

Group E3)

Also of particular interest among the possible additives is the group of the antioxidants and heat stabilizers E3).

These compounds are per se familiar to the skilled worker. By way of example of a multiplicity of suitable additions mention may be made of the following: chloranilic acid (2,5-dichloro-3,6-dihydroxy-1,4-benzoquinone), hydroquinone (1,4-dihydroxybenzene), Irganox 1330 (1,3,5-trimethyl-2,4,6-tris(3,5-di-tert-butyl-4-hydroxybenzyl)benzene, Vulkanox BHT (2,6-di-tert-butyl-4-methylphenol), 4-tert-butylpyrocatechol, compounds of the general formula E3.I)

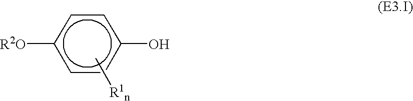

in which n is an integer in the range from 1 to 4, R¹ is a substituted or unsubstituted, linear or branched alkyl radical having 1 to 8 carbon atoms, preferably having 1 to 4 carbon atoms, an aryl radical or halogen, preferably chlorine, fluorine or bromine, and R² is hydrogen or a substituted or unsubstituted, linear or branched alkyl radical having 1 to 8 carbon atoms, preferably having 1 to 4 carbon atoms,

Irganox 1010 (3,5-bis(1,1-dimethylethyl-2,2-methylene-bis(4-methyl-6-tert-butyl)phenol),

Irganox 1035 (2,2′-thiodiethyl bis(3-(3,5-di-tert-butyl-4-hydroxyphenyl)propionate),

Irganox 1076 (octadecyl 3-(3,5-di-tert-butyl-4-hydroxyphenyl)propionate,

Topanol O, Cyanox 1790 (tris(4-tert-butyl-3-hydroxy-2,6-dimethylbenzyl)-5-triazine-2,4,6-(1H,3H,5H)trione), Irganox 1098, and the like.

Group E4)

A further group of particular additions is the group of the plasticizers (E4).

Plasticizers serve, for example, as agents for taking up peroxide components for the automatic 2-component mixing process (phlegmatizing agents), for regulating the compressive strength and flexural strength under tension, and for adjusting the surface tension.

Examples of plasticizers known for use in reactive resins include phthalates, adipates, chlorinated paraffins, urea resins, melamine resins, modified phenoxides, polyglycol urethanes.

The reactive resins contain preferably up to 7 parts by weight, in particular up to 2 parts by weight of a plasticizer per 10 parts by weight of the sum of A)+B).

In the context of the present invention a gas flow is passed over the surface to be coated, during the application of the coating material, by means of an overpressure ventilation device. One of the purposes of this gas flow is to remove any odor nuisance and/or health hazard vapors which originate from the coating material as rapidly as possible, so that during application of the coating material an odor nuisance and/or health hazard is, where possible, avoided, so that the wearing of special protective clothing is no longer absolutely necessary. Suitable overpressure ventilation devices are known to the skilled worker from the state of the art, and include, for example, fan devices, especially high-performance fans. In accordance with the invention one or more mobile overpressure ventilation devices are employed, the term “mobile overpressure ventilation devices” designating in this context overpressure ventilation devices which are not fixedly connected to their surroundings, in particular to a building. To be distinguished from these are fixed overpressure ventilation devices, i.e., overpressure ventilation devices which are connected fixedly to their surroundings, in particular to a building. The use of mobile overpressure ventilation devices is therefore especially advantageous since it allows the overpressure ventilation devices to be optimally sited and aligned in accordance with local circumstances. Thus, using mobile overpressure ventilation devices, which are readily portable and can be set up and aligned rapidly, it is possible to remove health-injurious vapors and gases effectively. The nature of the gas for use in accordance with the invention is arbitrary in principle. It has nevertheless proven particularly advantageous to pass air over the surface to be coated.

The composition of the gas flow over the time of the method is advantageously kept constant, in order to ensure very uniform curing conditions and hence uniform material properties of the coating. The temperature of the gas flow is preferably −20° C. to 100° C., more preferably 10° C. to 50° C., in particular 10° C. to 30° C.

The method of the invention is particularly suitable for the application of coatings in buildings, particularly in enclosed spaces and in large plant halls. The gas flow very rapidly removes any odor nuisance and/or health hazard vapors which originate from the coating material, so that their concentration in the building is lowered and there is compliance with the prescribed MAC levels.

The at least one overpressure ventilation device is preferably arranged at a distance in front of an opening in a wall of a building outside the building, in order to prevent, where possible, an excessive increase in pressure in the building and in order to allow highly effective gas exchange in the building. To prevent turbulence in the building and hence to ensure uniform curing of the coating material it has proven especially advantageous in this context to pass the gas flow through at least one venting means from the building, which is preferably disposed in the flow direction of the gas. Especially advantageous results can be achieved if a laminar flow of gas is passed over the surface to be coated.

In one particularly preferred embodiment of the method of the invention the gas flow generated by the at least one overpressure ventilation device is deflected with at least one deflector means, which is separate from the overpressure ventilation device, is at a distance from it, and is preferably portable, said deflector means being disposed between the overpressure ventilation device and the surface to be coated. Suitable deflector devices are known to the skilled worker from the state of the art, in particular from the publication EP 690 271 A, the disclosure content of which is hereby explicitly incorporated by reference.

They preferably embrace an inlet opening, an outlet opening, and a deflector member provided between the inlet opening and the outlet opening. Through the provision of a deflector means for a gas flow generated by the overpressure ventilation device it is possible with advantage to use existing overpressure ventilation device, such as are known, for example, from fire protection for the ventilation of interior spaces.

In a simple way the outlet opening of the deflector means is aligned in the direction of the surface to be coated and the inlet opening is aligned in the direction of the overpressure ventilation device. When the overpressure ventilation device is then set in operation, with the overpressure ventilation device emitting in the direction of the inlet opening, the gas flow strikes the deflector member between the inlet opening and the outlet opening of the deflector means, so that the gas flow is deflected in the direction of the surface to be coated, and the gases and vapors there are displaced by the inflowing gas glow.

The deflector means can advantageously be portable.

In order to maximize the efficiency of the device of the invention it is possible for the deflector member to be made of a gas-impermeable material. For this purpose it is possible to use, for example, plastics, metallic materials or coated substance.

The provision of a gas-impermeable material ensures that the greatest part of the gas flow emitted by the overpressure ventilation device is deflected and does not pass through the deflector member, as would be the case if a gas-permeable material were used. Precise alignment of the overpressure ventilation device to the deflector means can be made easier by the deflector means being connected to the overpressure ventilation device by way of cables, rods or the like.

Where at least two cables, rods or the like are provided for connecting the deflector means with the overpressure ventilation device, this device, if all of the cables, rods or the like have the same length, can be aligned precisely to the deflector member of the deflector means, so that the apparatus as a whole can be operated effectively.

Moreover, the cables, rods or the like prevent the deflector means being blown away by the overpressure ventilation device, since the deflector means is connected to the overpressure ventilation device and the forces which occur are taken up by the cables, rods or the like, owing to the dynamic pressure of the air flow generated by the overpressure ventilation device.

The distance between the deflector means and the overpressure ventilation device can be varied by way of quick-acting couplings mounted on the cables, rods or the like. The distance between the deflector means and the overpressure ventilation device can therefore be varied so as to achieve the best efficiency of the apparatus of the invention.

Furthermore, it is advantageous to fix the alignment of the outlet opening of the deflector means in the direction of the surface to be coated by means of customary fixings. In this context, in accordance with the invention, detachable fixing methods are especially preferred.

The direction in which the coating is applied is in principle arbitrary, but is advantageously chosen such that the coating material is applied in the opposite direction to the direction of gas flow. This ensures that any odor nuisance and/or health hazard vapors which originate from the coating material are removed directly away from the person carrying out application.

In the context of the present invention the application and the curing of the coating material take place preferably at a temperature in the range from −10° C. to +45° C., in particular in the range from +10° C. to +30° C.

1. A method of coating a surface, wherein a coating material having a viscosity less than 100 Pa.s, measured at 25° C., is applied to a surface to be coated, and is cured, wherein the coating material comprises a reactive resin comprising components
A) 1 part by weight of at least one ethylenically unsaturated compound,
B) 0-2 parts by weight of a (pre)polymer swellable or soluble in component A),
C) 0 to 0.15 parts by weight of at least one paraffin and/or wax,
D) a redox system wherein at least one component of the redox system is to be kept separate until the polymerization of the polymerizable constituents of the system, wherein the redox system comprises an accelerant and a peroxide catalyst or initiator in an amount sufficient for the cold curing of component A), and
E) customary additives and a gas flow is passed over the surface to be coated, during the application of the coating material, by means of at least one mobile overpressure ventilation device.

2. The method of claim 1, wherein the reactive resin comprises at least one acrylate, at least one methacrylate and/or at least one vinylaromatic as the ethylenically unsaturated compound in component A).

3. The method of claim 2, wherein the reactive resin comprises methyl methacrylate, n-butyl acrylate, butyl methacrylate, ethylhexyl acrylate and/or styrene as the ethylenically unsaturated compound in component A).

4. The method of claim 1, wherein the reactive resin comprises

| | |
|---|---|
| A-1) (meth)acrylate | 10-100% by wt., including |
| C₁-C₆ (meth)acrylate | 0-97% by wt., |
| ≧C₇ (meth)acrylate | 0-50% by wt. and |
| Polyfunctional | 0.1-10% by wt., |
| (meth)acrylates | |
| with or without | |
| A-2) comonomers | 0-90% by wt., including |
| vinyl aromatics | 0-30% by wt. and |
| vinyl esters | 0-30% by wt., |

wherein the sum of components A-1) and A-2) make up 100% by
weight of component A).

5. The method of claim 1, wherein the reactive resin comprises component E) in an amount in the range from 0 to 100 parts by weight per 10 parts by weight of the sum of components A) and B).

6. The method of claim 1, wherein component B) in the reactive resin comprises at least one (pre)polymer based on (meth)acrylates.

7. The method of claim 1, wherein the amount of component C) in the reactive resin is from 2.5 to 3.5 parts by weight per 100 parts by weight of the sum of components A) and B).

8. The method of claim 1 wherein component D) is a system comprising amines and dibenzoyl peroxide.

9. The method of claim 1, wherein the curing takes place at a temperature in the range from −10° C. to +45° C.

10. The method of claim 1, wherein the coating material is applied in the opposite direction relative to the gas flow direction.

11. The method of claim 1, wherein the coating material is applied in a building.

12. The method of claim 11, wherein the gas flow is passed over the surface to be coated, during the application of the coating material, by means of at least one overpressure ventilation device, wherein the at least one overpressure ventilation device is disposed at a distance in front of an opening in the wall of the building.

13. The method of claim 11, wherein the gas flow is passed through at least one venting means from the building.

14. The method of claim 1 wherein the gas flow comprises a laminar flow of gas which is passed over the surface to be coated.

15. The method of claim 1, wherein the gas flow generated by the at least one overpressure ventilation device is deflected with at least one deflector means, wherein the deflector means is separate from the overpressure ventilation device, is at a distance from the overpressure ventilation device, said deflector means being disposed between the overpressure ventilation device and the surface to be coated.

16. The method of claim 1, wherein component D) is a system comprising N,N-bis-(2-hydroxyethyl)-p-toluidine and dibenzoyl peroxide.

17. The method of claim 1, wherein the curing takes place at a temperature in the range from +10° C. to +30° C.

18. The method of claim 12, wherein the gas flow is passed through at least one venting means from the building.

19. The method of claim 13, wherein the venting means is disposed in the direction of the gas flow.

20. The method of claim 18, wherein the venting means is disposed in the direction of the gas flow.

21. The method of claim 15, wherein the deflector means is portable.
